(19) United States
(12) Patent Application Publication
(10) Pub. No.: US 2026/0257614 A1
(43) Pub. Date: Sep. 3, 2026

(54) HEADLIGHT CONTROL DEVICE FOR VEHICLE

(71) Applicant: TOYOTA JIDOSHA KABUSHIKI KAISHA, Toyota-shi (JP)

(72) Inventor: Tetsuya IKUTA, Miyoshi-shi (JP)

(73) Assignee: TOYOTA JIDOSHA KABUSHIKI KAISHA, Toyota-shi (JP)

(21) Appl. No.: 19/544,085

(22) Filed: Feb. 19, 2026

(30) Foreign Application Priority Data
Mar. 3, 2025 (JP) 2025-032984

(51) Int. Cl. B60Q 1/14

(52) U.S. Cl. CPC B60Q 1/1423

(57) ABSTRACT

The headlight control device for a vehicle controls light distribution of a lamp unit of a vehicle. The headlight control device for a vehicle includes an area determination unit that periodically determines presence or absence of an irradiatable area in a high beam of a lamp unit, and a light distribution pattern instruction unit that sets a light distribution pattern of the high beam for the lamp unit based on a determination result of the area determination unit. In a case where it is determined that the irradiatable area is present, the area determination unit determines presence or absence of the irradiatable area based on an on-off state of the high beam. In a case where it is determined that the irradiatable area is not present, the area determination unit determines that the irradiatable area is present after a predetermined first time has elapsed from the determination.

### CROSS-REFERENCE TO RELATED APPLICATION

This application claims priority to Japanese Patent Application No. 2025-032984 filed on March 3, 2025. The disclosure of the above-identified application, including the specification, drawings, and claims, is incorporated by reference herein in its entirety.

### BACKGROUND

### Technical Field

One aspect of the present disclosure relates to a headlight control device for a vehicle.

### Description of Related Art

As a technology related to a headlight control device for a vehicle that controls light distribution of a headlight of a vehicle, a light distribution control device described in WO 2022/270413 is known. In the light distribution control device described in WO 2022/270413, the light distribution of the headlight (light distribution variable lamp) is controlled such that a light shielding region (light shielding portion) is formed with respect to a vehicle in front of the vehicle.

### SUMMARY

In the device as described above, when the light shielding region of the headlight spreads in front of the vehicle, a gap through which a high beam is emittable disappears, so that the high beam is completely turned off. Here, in a scene (situation) in which the gap through which the high beam is emittable repeatedly appears and disappears frequently, the high beam is repeatedly turned on and off frequently, so that an occupant of the vehicle may feel annoyed.

Therefore, an object of one aspect of the present disclosure is to provide a headlight control device for a vehicle capable of reducing annoyance felt by the occupant.

A headlight control device for a vehicle according to one aspect of the present disclosure is a headlight control device for a vehicle that controls light distribution of a headlight of the vehicle, the headlight control device including: an area determination unit configured to periodically determine presence or absence of an irradiatable area in a high beam of the headlight; and

a setting unit configured to set, based on a determination result of the area determination unit, a light distribution pattern of the high beam for the headlight, in which the area determination unit is configured to:

determine, when the irradiatable area is determined to be present, presence or absence of the irradiatable area based on an on-off state of the high beam; and

determine, when the irradiatable area is determined to not be present, that the irradiatable area is present after a first time that is predetermined has elapsed from the determination.

According to one aspect of the present disclosure, it is possible to provide a headlight control device for a vehicle capable of reducing annoyance felt by an occupant.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a headlight control device for a vehicle according to one embodiment;

FIG. 2 is a flowchart showing processing of the headlight control device for a vehicle of FIG. 1;

FIG. 3 is a flowchart showing determination processing of the area determination unit of FIG. 1;

FIG. 4 is a diagram showing an example of an irradiation region and a dimming region of a lamp unit 3;

FIG. 5 is a diagram showing another example of the irradiation region and the dimming region of the lamp unit 3;

FIG. 6A is a table showing a correspondence relationship between a speed of the vehicle and a set first time;

FIG. 6B is a graph showing an example of the correspondence relationship of FIG. 6A;

FIG. 6C is a graph showing another example of the correspondence relationship of FIG. 6A; and

FIG. 6D is a table showing a correspondence relationship between the speed of the vehicle and a set traveling distance.

### DETAILED DESCRIPTION OF EMBODIMENTS

Hereinafter, embodiments will be described in detail with reference to the accompanying drawings. The same or corresponding elements in the drawings are designated by the same reference numerals, and redundant description thereof will be omitted.

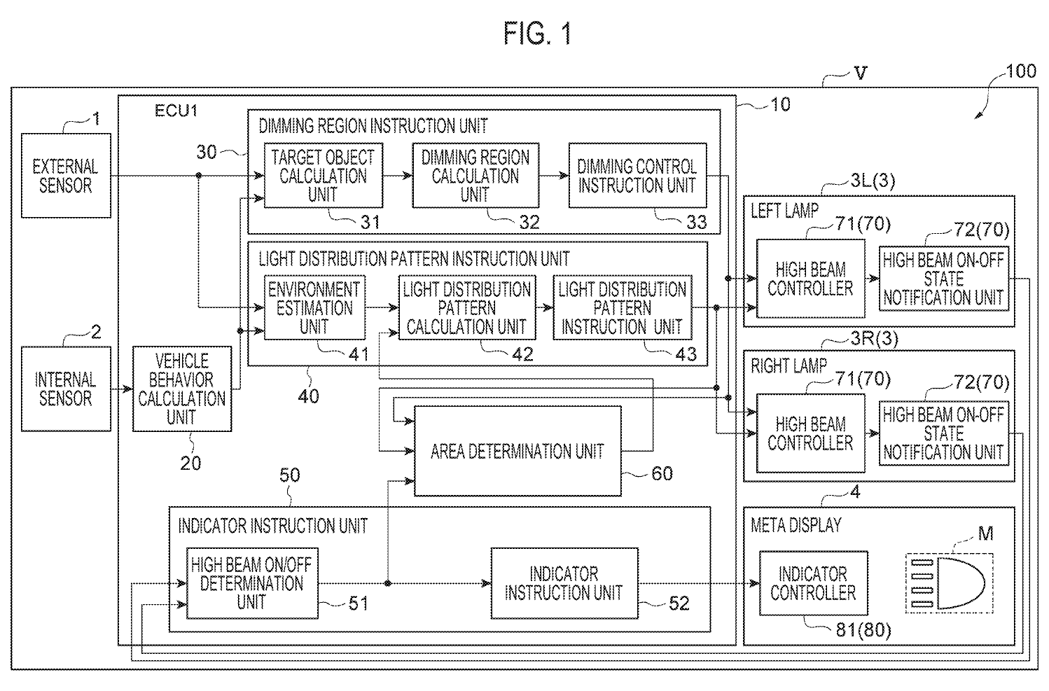

As shown in FIG. 1, a headlight control device for a vehicle 100 is mounted in a vehicle V. The vehicle V may be a passenger car or a freight car. The vehicle V can accommodate one or more occupants. The vehicle V may be an autonomous driving vehicle capable of autonomous driving. The vehicle V may be capable of manual driving by a driver. The headlight control device for a vehicle 100 has a light distribution control function of controlling light distribution of a lamp unit 3 of the vehicle V.

The light distribution control function is a control function related to the high beam of the lamp unit 3 of the vehicle V. The light distribution control function is, for example, an adaptive high beam system (AHS). The adaptive high beam system is, for example, a function of automatically shielding or dimming the high beam solely in a range in which another vehicle is present in front of the vehicle V at night. The front of the vehicle V corresponds to an irradiation direction of the lamp unit 3 of the vehicle V. The headlight control device for a vehicle 100 comprises an electronic control unit (ECU) 10.

The ECU 10 is an electronic control unit having a central processing unit (CPU), a read only memory (ROM), a random access memory (RAM), and the like. The ECU 10 realizes various functions by, for example, loading a program stored in the ROM into the RAM and executing the program loaded in the RAM by the CPU. Some functions of the ECU 10 may be executed by a server that can communicate with the vehicle V. The ECU 10 may be configured by a plurality of electronic units. An external sensor 1, an internal sensor 2, the lamp unit 3 (headlight), and a display 4 are connected to the ECU 10.

The external sensor 1 is a detection device that detects a situation around the vehicle V. The external sensor 1 includes a camera (on-vehicle camera). The external sensor 1 may include a radar sensor. The camera is an imaging device that images the situation in front of the vehicle V. The camera is provided, for example, on a back surface of an inner mirror (rearview mirror) on a back side of a windshield of the vehicle V, and images the front of the vehicle V. The camera transmits a front imaging image related to the situation in front of the vehicle V to the ECU 10.

The radar sensor is a detection device that detects an object around the vehicle V by using radio waves (for example, millimeter waves) or light. The object around the vehicle V includes a front vehicle that is another vehicle traveling in front of the vehicle V. The radar sensor may include, for example, a millimeter wave radar or a light detection and ranging (LiDAR). The radar sensor transmits information on the detected object to the ECU 10.

The internal sensor 2 is a detection device that detects a traveling state of the vehicle V. The internal sensor 2 includes a vehicle speed sensor. The vehicle speed sensor is a detector that detects the speed of the vehicle V. As the vehicle speed sensor, for example, a vehicle wheel speed sensor that detects a rotation speed of a vehicle wheel of the vehicle V or a drive shaft that rotates integrally with the vehicle wheel is used. The internal sensor 2 may include an acceleration sensor, a yaw rate sensor, and a steering angle sensor. The internal sensor 2 transmits information on the detected traveling state of the vehicle V to the ECU 10.

The lamp unit 3 includes a headlamp that illuminates the front of the vehicle V. The headlamp includes a left lamp 3L provided at a left front end portion of the vehicle V and a right lamp 3R provided at a right front end portion of the vehicle V. The lamp unit 3 is configured to adjust the amount of light for each of a plurality of light distribution regions (irradiation regions). For example, the lamp unit 3 includes a plurality of LEDs arranged side by side, and the amount of irradiation in any light distribution region can be increased or decreased by adjusting the amount of energization of any LED. The lamp unit 3 is not particularly limited, and various known headlamps may be used.

As will be described later, the lamp unit 3 comprises an ECU 70. The ECU 70 independently controls each of the LEDs of the lamp unit 3 based on an instruction of the ECU 10. In a case where the ECU 70 controls the specific LED to be turned on, the specific LED emits light to the corresponding light distribution region.

The display 4 is, for example, a display device that is provided in a vehicle cabin of the vehicle V and presents information to the occupant of the vehicle V visually. The display 4 may be any of a meter display, a center display, a multi information display (MID), or a head-up display (HUD). The display 4 displays various types of information in response to a control signal of the ECU 10. The display 4 displays, for example, a high beam indicator M indicating the on-off state of the high beam.

The display 4 comprises an ECU 80. The ECU 80 is, for example, an electronic control unit having the same configuration as the ECU 10. The ECU 80 is connected to the ECU 10. The lamp unit 3 may not comprise the ECU 80, and the function of the ECU 80 may be executed by the ECU 10. The ECU 80 has an indicator controller 81 as a functional configuration. The indicator controller 81 performs control of displaying or not displaying the high beam indicator M of the display 4 based on the on-off state of the high beam. Specifically, the indicator controller 81 performs control of displaying or not displaying the high beam indicator M of the display 4 based on an instruction of the ECU 10 (indicator instruction unit 52 described later).

As a functional configuration, the ECU 10 has a vehicle behavior calculation unit 20, a dimming region instruction unit 30, a light distribution pattern instruction unit 40, an indicator instruction unit 50, and an area determination unit 60 (area determination unit).

The vehicle behavior calculation unit 20 recognizes the traveling state (behavior) of the vehicle V based on the detection result of the internal sensor 2. The traveling state includes the vehicle speed of the vehicle V. The traveling state may include an acceleration and a yaw rate of the vehicle V. The vehicle behavior calculation unit 20 recognizes the vehicle speed of the vehicle V based on, for example, information related to the vehicle speed from the vehicle speed sensor. The vehicle behavior calculation unit 20 may recognize the acceleration of the vehicle V based on the acceleration information of the acceleration sensor. The ECU 10 may recognize an orientation of the vehicle V based on information related to a yaw rate from the yaw rate sensor or information related to a steering angle from the steering angle sensor. The vehicle behavior calculation unit 20 transmits information on the recognized traveling state of the vehicle V to a target object calculation unit 31 of the dimming region instruction unit 30.

The dimming region instruction unit 30 includes the target object calculation unit 31, a dimming region calculation unit 32, and a dimming control instruction unit 33.

The target object calculation unit 31 detects a target object present in front of the vehicle V and calculates information on the target object based on the information from the external sensor 1 and the information on the traveling state of the vehicle V from the vehicle behavior calculation unit 20. The information on the target object includes, for example, the number of target objects (hereinafter, referred to as the number of target objects), the position, the speed, and the direction of the target object. The target object calculation unit 31 detects the target object based on, for example, an imaging image of the camera. The target object is, for example, a light source including ambient light and light from another vehicle. The ambient light includes light from a street lamp, a building, and the like. The light from another vehicle is light from a front vehicle, and includes, for example, a headlamp of an oncoming vehicle and a tail lamp of a preceding vehicle. In addition, the light from another vehicle may include a headlamp and a tail lamp of a vehicle traveling in a direction intersecting with a traveling direction of the vehicle V at an intersection. The target object calculation unit 31 recognizes the type (ambient light or light from another vehicle) of the detected light source by a known method. In addition, the target object calculation unit 31 may improve the detection accuracy of the target object based on the information on the traveling state of the vehicle V.

The dimming region calculation unit 32 calculates the dimming region of the lamp unit 3 based on the calculation result of the target object calculation unit 31. The dimming region is a region in which the lamp unit 3 is dimmed or shielded, and is, for example, a region including a light source detected in front of the vehicle V. The dimming control instruction unit 33 instructs (requests) a high beam controller 71 described later to shield or dim the high beam emitted to the dimming region based on the calculation result of the dimming region calculation unit 32. In addition, the dimming control instruction unit 33 transmits the information on the target object calculated by the target object calculation unit 31 to the high beam controller 71.

The light distribution pattern instruction unit 40 includes an environment estimation unit 41, a light distribution pattern calculation unit 42, and a light distribution pattern instruction unit 43 (setting unit). The environment estimation unit 41 estimates a peripheral environment that is an environment around the vehicle V based on the information from the external sensor 1 and the information on the traveling state of the vehicle V from the vehicle behavior calculation unit 20. The peripheral environment includes a road surface shape and brightness (illuminance) around the vehicle V.

The light distribution pattern calculation unit 42 performs calculation for determining the light distribution pattern of the high beam based on the information on the peripheral environment estimated by the environment estimation unit 41 and the determination result of the area determination unit 60. The light distribution pattern includes, for example, a low beam pattern in which the high beam is turned off and a plurality of high beam patterns in which the high beam is turned on. The high beam patterns may have different irradiation ranges of the high beam based on the vehicle speed of the vehicle V. The high beam pattern may be one or more. The type of the light distribution pattern is not limited to the low beam pattern and the high beam pattern, and may be another irradiation pattern.

The light distribution pattern calculation unit 42 sets the light distribution pattern of the high beam based on the information from the environment estimation unit 41 and the determination result of the area determination unit 60 described later. For example, in a case where the area determination unit 60 determines that the irradiatable area is not present, the light distribution pattern calculation unit 42 sets the light distribution pattern to the low beam pattern. That is, in this case, the light distribution pattern calculation unit 42 sets the light distribution pattern to the low beam pattern regardless of the information from the environment estimation unit 41. On the other hand, in a case where the area determination unit 60 determines that the irradiatable area is present, the light distribution pattern calculation unit 42 sets the light distribution pattern (in this example, the low beam pattern or the high beam patterns) based on the information on the peripheral environment estimated by the environment estimation unit 41.

The light distribution pattern instruction unit 43 instructs the high beam controller 71 to set the light distribution pattern of the high beam for the lamp unit 3 based on the light distribution pattern determined by the light distribution pattern calculation unit 42 (in another view, based on the determination result of the area determination unit 60).

The indicator instruction unit 50 includes a high beam on/off determination unit 51 and an indicator instruction unit 52. The high beam on/off determination unit 51 determines whether the high beam is in the on state based on information on the high beam on state from a high beam on state notification unit 72 described later. The high beam on/off determination unit 51 determines that the high beam is in the on state in a case where at least one LED that emits the high beam is turned on. On the other hand, the high beam on/off determination unit 51 determines that the high beam is in the off state in a case where all the LEDs that emit the high beam are in the off state.

The indicator instruction unit 52 instructs the indicator controller 81 of the display 4 to display or not display the high beam indicator M based on the determination result from the high beam on/off determination unit 51. Specifically, in a case where the high beam on/off determination unit 51 determines that the high beam is in the on state, the indicator instruction unit 52 instructs to perform display of the high beam indicator M. On the other hand, in a case where the high beam on/off determination unit 51 determines that the high beam is in the off state, the indicator instruction unit 52 instructs to perform non-display of the high beam indicator M.

The area determination unit 60 periodically determines presence or absence of the irradiatable area in the high beam of the lamp unit 3. That is, the area determination unit 60 repeatedly determines presence or absence of the irradiatable area at predetermined intervals. The irradiatable area refers to a region in which the high beam of the lamp unit 3 can be emitted. The irradiatable area includes a gap through which the high beam can be emitted in front of the vehicle V.

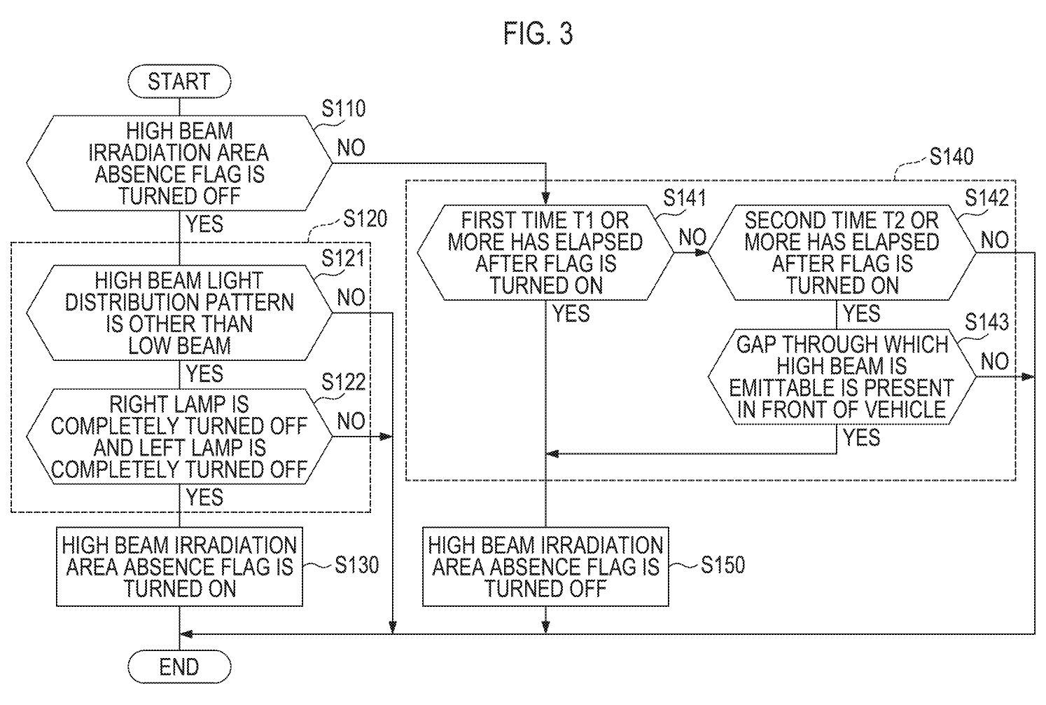

Here, the area determination unit 60 performs the determination by using a high beam irradiation area absence flag (see FIG. 3). The high beam irradiation area absence flag is a flag on a program indicating that the high beam irradiatable area is not present. Hereinafter, the high beam irradiation area absence flag may be simply referred to as a “flag”. In a case where the flag is ON, it means that the high beam irradiatable area is not present. In a case where the flag is OFF, it means that the high beam irradiatable area is present.

In a case where it is determined that the irradiatable area is present (in a case where the flag is OFF), the area determination unit 60 determines presence or absence of the irradiatable area based on the on-off state of the high beam. The phrase “in a case where it is determined that the irradiatable area is present” means a case where it is determined that the irradiatable area is present in the previous determination by the area determination unit 60.

Specifically, in a case where it is determined that the irradiatable area is present (in a case where the flag is OFF), the area determination unit 60 determines presence or absence of the irradiatable area based on the information from the dimming control instruction unit 33 and the light distribution pattern instruction unit 43 and the information from the high beam on/off determination unit 51. More specifically, the area determination unit 60 determines presence or absence of the irradiatable area based on the light distribution pattern set by the light distribution pattern instruction unit 43 and the on-off state of the high beam determined by the high beam on/off determination unit 51. For example, in a case where the light distribution pattern is set to a pattern other than the low beam pattern (in this example, any of the high beam patterns) and the high beam is completely turned off, the area determination unit 60 determines that the irradiatable area is not present (flag is turned ON) (see S121, S122, and S130 in FIG. 3).

In a case where it is determined that the irradiatable area is not present (in a case where the flag is ON), the area determination unit 60 determines that the irradiatable area is present after a predetermined first time T1 has elapsed from the determination (flag is turned OFF) (see S141 and S150 in FIG. 3). The first time T1 includes a time for preventing the high beam from being fixed (preventing the high beam from being continuously turned off). The first time T1 is set to any time with a length that can suppress the irradiatable area from being frequently switched. The first time T1 is a maximum time (maximum flag ON time) for which the flag is in the ON state, which will be described later. In addition, in a case where it is determined that the irradiatable area is not present (in a case where the flag is ON), the area determination unit 60 determines that the irradiatable area is present in a case where the gap through which the high beam can be emitted is present in front of the vehicle V before the first time T1 has elapsed from the determination and after a predetermined second time T2 shorter than the first time T1 has elapsed (flag is turned OFF) (see S141 to S143 and S150 in FIG. 3). The second time T2 is set to any time in a range shorter than the first time. The second time T2 includes a time for fixing the high beam for a constant time (time for continuously turning off the high beam). From another viewpoint, the second time T2 includes a time for suppressing flickering in which the high beam is repeatedly turned on and off. The second time T2 is a minimum time (minimum flag ON time) for which the flag is in the ON state.

Here, in the present embodiment, the presence or absence of the gap through which the high beam can be emitted is determined based on, for example, the number of target objects recognized in front of the vehicle V. Specifically, the area determination unit 60 determines that the gap is present in a case where the number of target objects recognized in front of the vehicle V is less than a predetermined threshold value based on the information from the dimming control instruction unit 33. The area determination unit 60 may not determine the presence or absence of the gap based on the information from the dimming control instruction unit 33, or may calculate the number of target objects based on the information from the external sensor 1 and the internal sensor 2 and determine the presence or absence of the gap based on the calculation result.

In addition, in the present embodiment, the predetermined threshold value of the number of target objects is changed based on the state (traveling state) of the vehicle V and the situation around the vehicle V. The threshold value of the number of target objects is set to be larger as the speed of the vehicle V is lower and smaller as the speed of the vehicle V is higher. In addition, the threshold value of the number of target objects may be changed according to an area or a road type in which the vehicle V is traveling by using map information. For example, the threshold value of the number of target objects may be set to be smaller in a case where the vehicle V is traveling on a highway and larger in a case where the vehicle V is traveling on a general road. The predetermined threshold value of the number of target objects may not be changed based on the state of the vehicle V and the situation around the vehicle V, and may be a fixed value.

The area determination unit 60 may not determine the presence or absence of the gap based on the number of target objects. The area determination unit 60 may determine the presence or absence of the gap based on GPS or communication information (communication information between the vehicle V and another vehicle or cloud information). Specifically, the area determination unit 60 may determine that the gap is not present (flag is turned ON) in a case where the number of traveling vehicles (including oncoming vehicles) in front of the current position is larger than a predetermined number based on at least one of the position or the number of the traveling vehicles, and may determine that the gap is present (flag is turned OFF) in a case where the number of the traveling vehicles in front of the current position is smaller than the predetermined number.

The lamp unit 3 comprises the ECU 70 for controlling the on-off state of the lamp unit 3. The ECU 70 is, for example, an electronic control unit having the same configuration as the ECU 10. The ECU 70 is connected to the ECU 10. The lamp unit 3 may not comprise the ECU 70, and the function of the ECU 70 may be executed by the ECU 10. As a functional configuration, the ECU 70 has the high beam controller 71 and the high beam on state notification unit 72.

The high beam controller 71 controls the on-off state of the high beam based on an instruction from the ECU 10 (dimming control instruction unit 33 and light distribution pattern instruction unit 43). The high beam controller 71 may perform control of shielding or dimming the dimming region based on the instruction of the dimming control instruction unit 33 after performing control based on the light distribution pattern determined by the light distribution pattern instruction unit 43. The high beam on state notification unit 72 notifies the high beam on/off determination unit 51 of the on-off state of the high beam.

The high beam controller 71 controls the on-off state of each LED of the lamp unit 3 based on not only the instruction from the ECU 10 but also the characteristics of the lamp unit 3 (for example, an irradiation range, a resolution, and a light distribution design). In a case where the high beam controller 71 determines that the light distribution region cannot be turned on due to the characteristics of the lamp unit 3 even in a case where the on instruction is issued from the ECU 10, the high beam controller 71 turns off the high beam. Specifically, there is a case where the light shielding region (dimming region) is included in the irradiation range of the LED for which the on instruction is issued from the ECU 10, and in this case, the high beam controller 71 does not turn on the LED even in a case where the on instruction is issued from the ECU 10, and sets the LED to the off state. As described above, since the high beam controller 71 considers not only the instruction from the ECU 10 but also the characteristics of the lamp unit 3, the high beam controller 71 may perform control different from the instruction of the ECU 10.

Here, in a case where the light shielding region of the high beam spreads widely in front of the vehicle V, a gap through which the high beam can be emitted disappears, and the high beam may be completely turned off. In a scene (situation) in which the gap through which the high beam can be emitted repeatedly appears and disappears, the high beam is repeatedly turned on and off frequently, so that the occupant of the vehicle may feel annoyed. In addition, in a case where the high beam indicator repeatedly turns on and off frequently in response to the on-off of the high beam, the occupant of the vehicle V may feel more annoyed.

The phenomenon of repeatedly turning on and off the high beam frequently may occur in a scene (situation) in which the gap through which the high beam can be emitted repeatedly appears and disappears or in a case where the irradiation region before and after the irradiation angle region (near the angle region) of the LED of the lamp unit 3, which can be irradiated, is continued. In particular, this phenomenon may occur in a case where the irradiation region that is similar to the characteristic of the irradiation angle of the LED of the lamp unit is continued.

For example, this phenomenon may occur in a high beam unit (particularly, a medium resolution high beam unit between a low resolution and a high resolution) that does not have a high resolution and an up-down resolution. In a case where the low resolution high beam unit is used, the irradiatable area is easily filled (that is, since the irradiatable area of each LED is relatively wide, the light shielding region is easily included in the irradiatable area of each LED), and the LED of the high beam is easily completely turned off (the high beam is easily turned into the low beam, and the complete turning off of the high beam is easily continued). However, the high beam may be turned on and off in a wide range before and after the resolution of the high beam unit. In addition, in the medium resolution high beam unit, the LED is more likely to be partially turned on than in the low resolution high beam unit. However, in a case where the resolution is not sufficiently high, the light shielding region is included in the irradiatable area of each LED, and the LED may be immediately turned off. As a result, the high beam may be frequently turned on and off.

On the other hand, in a case where the high resolution or the up-down resolution high beam unit is used, the irradiatable area is likely to remain (that is, since the irradiatable area of each LED is relatively narrow, the light shielding region is unlikely to be included in the irradiatable area of each LED), so that the possibility that the LED is completely turned off is relatively low. As a result, in the high resolution or the up-down resolution high beam unit, the high beam is likely to be continuously turned on, so that the high beam is unlikely to be turned on and off.

As described above, the scene in which the phenomenon of repeatedly turning on and off the high beam frequently occurs varies depending on the characteristics of the lamp unit. Therefore, a lamp unit is needed that can be commonly applied to lamp units having different characteristics and that can suppress the on-off of the high beam.

In the present embodiment, the system (ECU 10) transmits the high beam on instruction to the ECU 70 in a case where the high beam can be partially turned on based on the detection result of the front vehicle. However, in some cases, the ECU 70 may not be able to turn on the light source (LED) of the high beam depending on the situation on the lamp unit 3 side. By detecting such a scene and temporarily stopping the high beam from being turned on, the frequency of the on-off of the high beam can be suppressed. The ECU 10 temporarily stops the high beam on instruction in a case where the high beam is completely turned off when the high beam on request is issued. Specifically, in a case where the light distribution pattern is set to a pattern other than the low beam pattern and the high beam is completely turned off, the area determination unit 60 of the ECU 10 determines that the irradiatable area is not present (flag is turned ON) (see S121, S122, and S130 in FIG. 3). Then, after a predetermined first time T1 has elapsed from the determination, it is determined that the irradiatable area is present (flag is turned OFF) (see S141 and S150 in FIG. 3). As a result, since the high beam on instruction of the ECU 10 is temporarily stopped, the frequent switching of the on-off of the high beam can be suppressed. As a result, the annoyance felt by the occupant can be reduced. In addition, in a case where it is determined that the irradiatable area is present, the area determination unit 60 determines presence or absence of the irradiatable area based on the on-off state of the high beam regardless of the characteristics of the lamp unit 3. As a result, the headlight control device for a vehicle 100 can be commonly applied to the lamp units having different characteristics. That is, by determining the presence or absence of the irradiatable area based on the current on-off state of the lamp unit, a system that is not annoying to the user can be provided by a common control method even in a vehicle having lamp units with different resolutions.

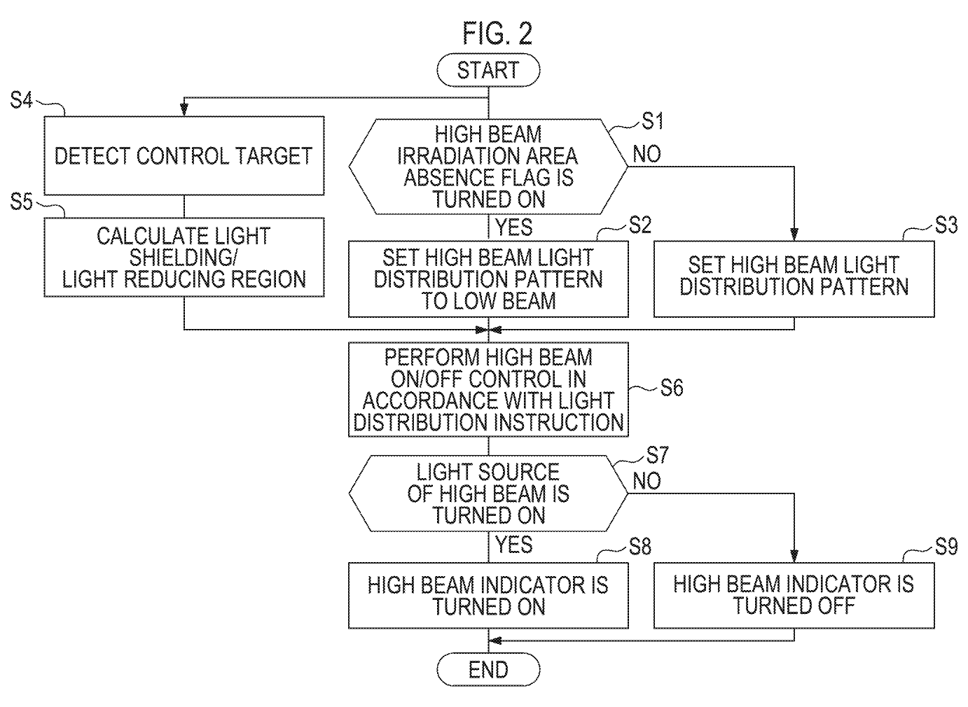

Next, an example of processing by the headlight control device for a vehicle 100 of the present embodiment will be described with reference to the flowchart of FIG. 2. The series of processing is executed periodically, for example, in a case where the vehicle V is traveling and the lamp unit 3 is operating. In addition, in the present embodiment, the processing is executed by the ECU 10, the ECU 70, and the ECU 80. However, the processing may be executed solely by the ECU 10.

As shown in FIG. 2, first, the area determination unit 60 of the ECU 10 determines whether the high beam irradiatable area absence flag is ON (S1). In a case of YES in S1, the light distribution pattern calculation unit 42 and the light distribution pattern instruction unit 43 of the ECU 10 set the light distribution pattern of the high beam to the low beam pattern (S2). On the other hand, in a case of NO in S1, the ECU 10 sets the light distribution pattern of the high beam based on the information from the environment estimation unit 41 (S3).

In addition, in parallel with S1 to S3, the target object calculation unit 31 detects the target object (control target) present in front of the vehicle V (S4). In addition, after S4, the target object calculation unit 31 calculates the dimming region of the high beam (S5).

After executing S3 or S2 and executing S5, the high beam controller 71 of the ECU 70 controls the on-off state of the high beam based on the light distribution instruction (instruction from the dimming control instruction unit 33 and the light distribution pattern instruction unit 43) from the ECU 10 (S6). After S6, the high beam on/off determination unit 51 of the ECU 10 determines whether the high beam is turned on (whether the high beam is in the on state) (S7). In a case of YES in S7, the indicator controller 81 of the ECU 80 turns on (displays) the high beam indicator M of the display 4. In a case of NO in S7, the indicator controller 81 turns off (does not display) the high beam indicator M of the display 4.

Next, an example of the determination processing of the area determination unit 60 will be described with reference to the flowchart of FIG. 3. The determination processing is executed independently of the series of processing by the headlight control device for a vehicle 100 described above, for example. The determination processing is executed periodically, for example, in a case where the vehicle V is traveling and the lamp unit 3 is operating. The determination processing may be executed, for example, at the same cycle as the series of processing by the headlight control device for a vehicle 100 or at any cycle.

First, the area determination unit 60 determines whether the high beam irradiatable area absence flag is OFF (S110). In a case of YES in S110 (in a case where the flag is OFF), the flag ON transition determination is executed (S120). In S120, first, it is determined whether the light distribution pattern is set to a pattern other than the low beam pattern (S121). In a case of YES in S121, it is determined whether the high beams of the right lamp 3R and the left lamp 3L are completely turned off (S122). In a case of YES in S122, the flag is turned ON (S130). In S130, the flag may be immediately turned ON in a case of YES in S122, or the flag may be turned ON after a predetermined time has elapsed from a case of YES in S122. On the other hand, in a case of NO in S121 or S122, the flag is maintained in the OFF state. S120 includes S121 and S122.

In a case of NO in S110 (in a case where the flag is ON), the flag OFF transition determination is executed (S140). In S140, first, it is determined whether the first time T1 has elapsed from the flag ON (S141). In a case of YES in S141, the flag is turned OFF (S150). In a case of NO in S141, it is determined whether the second time T2 has elapsed from the flag ON (S142). In a case of YES in S142, it is determined whether the gap through which the high beam can be emitted is present in front of the vehicle V (S143). In a case of YES in S143, the flag is turned OFF (S150). S140 includes S141 to S143.

In the headlight control device for a vehicle 100, in a case where it is determined that the irradiatable area is not present (in a case where the flag is ON), the area determination unit 60 determines that the irradiatable area is present after a predetermined first time T1 has elapsed from the determination (flag is turned OFF) (see S141 and S150 in FIG. 3). As a result, the frequent switching of the on-off of the high beam can be suppressed. As a result, the annoyance felt by the occupant can be reduced. In addition, in a case where it is determined that the irradiatable area is present (in a case where the flag is OFF), the area determination unit 60 determines presence or absence of the irradiatable area based on the on-off state of the high beam (flag is turned ON) (see S121, S122, and S130 in FIG. 3). That is, the area determination unit 60 determines the presence or absence of the irradiatable area regardless of the characteristics of the lamp unit 3. As a result, the headlight control device for a vehicle 100 can be commonly applied to the lamp units having different characteristics.

In the headlight control device for a vehicle 100, in a case where it is determined that the irradiatable area is not present (in a case where the flag is ON), the area determination unit 60 determines that the irradiatable area is present in a case where the gap through which the high beam can be emitted is present in front of the vehicle V before the first time T1 has elapsed from the determination and after a predetermined second time T2 shorter than the first time T1 has elapsed (flag is turned OFF) (see S141 to S143 and S150 in FIG. 3). As a result, it is possible to suppress the determination that the irradiatable area is not present (the flag is maintained in the OFF state) even in a case where the gap through which the high beam can be emitted is present in front of the vehicle after the predetermined second time T2 has elapsed from the determination that the irradiatable area is not present (after the flag is turned ON). Therefore, it is possible to suppress the high beam from being unnecessarily turned off.

In the headlight control device for a vehicle 100, the predetermined threshold value of the number of target objects is changed based on the state (traveling state) of the vehicle V and the situation around the vehicle V. As a result, it is possible to more appropriately determine the presence or absence of the high beam irradiatable area.

In the headlight control device for a vehicle 100, the indicator controller 81 performs control of displaying or not displaying the high beam indicator M of the display 4 based on the on-off state of the high beam. In such a configuration, as the frequent switching of the on-off of the high beam is suppressed, the frequent switching of the high beam indicator is also suppressed. Therefore, it is possible to suppress the user of the vehicle from feeling annoyed by the high beam indicator.

Although the embodiment has been described above, one aspect of the present disclosure is not limited to the embodiment. One aspect of the present disclosure can be implemented in various forms by various changes and improvements based on the knowledge of those skilled in the art, in addition to the embodiment.

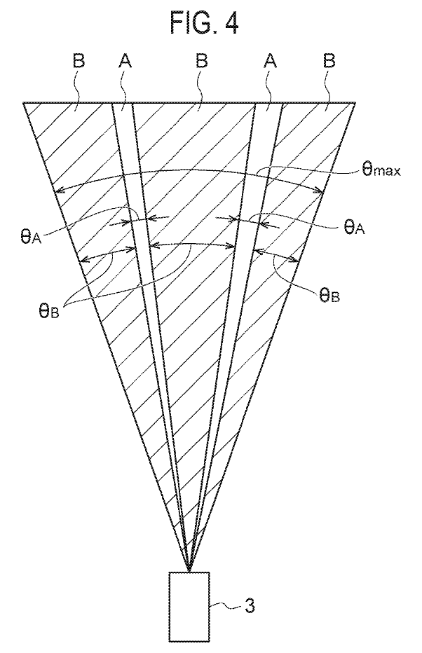

In the embodiment, the flag ON transition determination is executed based on the fact that the lamp unit 3 is completely turned off, but the present disclosure is not particularly limited to such a form. For example, the flag ON transition determination may be executed based on an irradiation angle θ_{A} of the high beam. As shown in FIG. 4, the irradiation angle θ_{A} is an angle indicating an irradiation range of the irradiation region A (irradiatable area, gap). The irradiation angle θ_{A} is calculated based on the dimming region B calculated based on the information from the external sensor 1. The irradiation angle θ_{A} is calculated, for example, by subtracting a dimming angle θ_{B} from a maximum irradiation angle θₘₐₓ of the high beam. Here, the maximum irradiation angle θₘₐₓ is an angle indicating the maximum irradiation range in which the high beam can be emitted. The dimming angle θ_{B} is an angle indicating a dimming range of the dimming region B.

For example, as in the example of FIG. 4, the area determination unit 60 may turn the flag ON in a case where the irradiation region A is relatively narrow and the irradiation angle θ_{A} is less than a predetermined threshold value. In addition, the area determination unit 60 may calculate a ratio of the total value of the dimming angles θ_{B} to the maximum irradiation angle θₘₐₓ, and may turn the flag ON in a case where the ratio is equal to or larger than a predetermined threshold value.

In the embodiment, the flag OFF transition determination is executed based on the number of target objects, but the present disclosure is not particularly limited to such a form. For example, the flag OFF transition determination may be executed based on the irradiation angle θ_{A} described above.

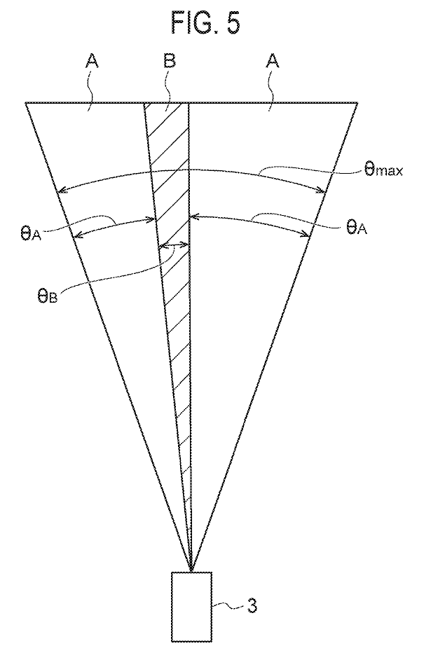

For example, the area determination unit 60 may turn the flag OFF in a case where the irradiation angle θ_{A} is equal to or larger than a predetermined threshold value. Specifically, as in the example of FIG. 5, the area determination unit 60 turns the flag OFF in a case where the irradiation region A is relatively wide and the irradiation angle θ_{A} is equal to or larger than a predetermined threshold value. In addition, the area determination unit 60 may turn the flag OFF in a case where the ratio of the total value of the dimming angles θ_{B} to the maximum irradiation angle θₘₐₓ is less than a predetermined threshold value.

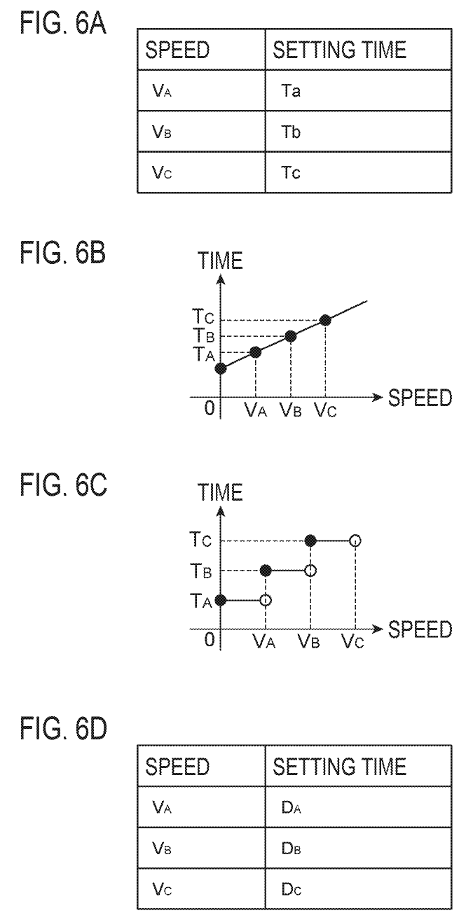

In addition, in the embodiment, the first time T1 is a fixed value, but the first time T1may not be a fixed value and may be changed, for example, in response to the speed of the vehicle V. For example, the first time T1 may be changed based on the table (constant map) shown in FIG. 6A. In this case, the first time T1 (set time) is set to T_{A}, T_{B}, and T_{C} (T_{A} < T_{B} < T_{C}) in response to the speeds V_{A}, V_{B}, and V_{C} (V_{A} < V_{B} < V_{C}) of the vehicle V, for example. In addition, as shown in FIG. 6B, the first time T1 may increase in proportion to the speed of the vehicle V. In addition, as shown in FIG. 6C, the first time T1 may be constant at T_{A} from a speed of 0 to V_{A}, may be constant at T_{B} from a speed of V_{B} to V_{C}, and may be constant at T_{C} in a case where the speed of the vehicle V is V_{C} or higher. Similarly, the second time T2 may be changed in response to the speed.

In addition, in the embodiment, the flag OFF transition determination is performed based on the first time T1, but the flag OFF transition determination may be performed based on the traveling distance instead of the first time T1. For example, the traveling distance may be calculated based on the speed and the traveling time of the vehicle V, and the OFF transition determination may be performed based on the traveling distance. For example, the flag may be turned OFF in a case where the traveling distance exceeds a predetermined distance threshold value (for example, 1 km). In addition, the distance threshold value (set traveling distance) may be changed based on the table shown in FIG. 6D. In this case, the distance threshold value is set to D_{A}, D_{B}, and D_{C} in response to the speeds V_{A}, V_{B}, and V_{C}, for example. In addition, the distance threshold value may be changed by map information, information on the peripheral environment of the vehicle V, and the like.

In addition, in the embodiment, the flag OFF transition determination may not be performed based on the second time T2. That is, S142 and S143 may be omitted. In addition, the ECU 80 of the display 4 may not have the indicator controller 81. In addition, in the embodiment, the lamp unit 3 is adopted as the headlight, but the present disclosure is not limited to this, and various known headlights may be adopted.

What is claimed is:

1. A headlight control device for a vehicle that controls light distribution of a headlight of the vehicle, the headlight control device comprising:
an area determination unit configured to periodically determine presence or absence of an irradiatable area in a high beam of the headlight; and
a setting unit configured to set, based on a determination result of the area determination unit, a light distribution pattern of the high beam for the headlight, wherein the area determination unit is configured to:
determine, when the irradiatable area is determined to be present, presence or absence of the irradiatable area based on an on-off state of the high beam; and
determine, when the irradiatable area is determined to not be present, that the irradiatable area is present after a first time that is predetermined has elapsed from the determination.

2. The headlight control device according to claim 1, wherein the area determination unit is configured to determine, when the irradiatable area is determined to not be present, that the irradiatable area is present in a case where a gap through which the high beam is emittable is present in front of the vehicle before the first time has elapsed from the determination and after a predetermined second time shorter than the first time has elapsed.

3. The headlight control device according to claim 2, wherein:
the area determination unit is configured to determine, when the number of target objects recognized in front of the vehicle is less than a predetermined threshold value, that the gap is present; and
the predetermined threshold value is changed based on a state of the vehicle and a situation around the vehicle.

4. The headlight control device according to claim 1, further comprising an indicator controller configured to change, based on the on-off state of the high beam, an indicator indicating the on-off state of the high beam to be displayed or not displayed.
